(19) United States
(12) Patent Application Publication
(10) Pub. No.: US 2026/0073813 A1
(43) Pub. Date: Mar. 12, 2026

(54) VEHICLE DIAGNOSTIC DIGITAL TRAINING SYSTEM

(71) Applicant: Innova Eletronics Corporation, Irvine, CA (US)

(72) Inventors: Phuong Pham, Fountain Valley, CA (US); Ly Bach, Ho Chi Minh City (VN); Hoang Nguyen, Dinh Quan District (VN); Tai Mai, Duc Trong District (VN); Keith Andreasen, Garden Grove, CA (US); Kiet Tran, Tan Chau Town (VN); Benjamin Pham, Fountain Valley, CA (US); Thuan Cong HUYNH, Ho Chi Minh City (VN); Hoang TO, Binh Dinh (VN); Truong Hai Lam NGUYEN, Ho Chi Minh City (VN)

(21) Appl. No.: 18/882,625

(22) Filed: Sep. 11, 2024

(51) Int. Cl. G09B 19/24

(52) U.S. Cl. CPC G09B 19/24

(57) ABSTRACT

An automotive diagnostic digital training system comprising a virtual vehicle including a data simulating processor and a database in communication with the data simulating processor and having simulated, vehicle-specific vehicle data stored thereon. The data simulating processor is configured to access simulated vehicle data stored on the database and generate a signal including a desired set of simulated vehicle data. A student workstation is disposable in communication with the virtual vehicle. The student workstation includes a handheld diagnostic device configured to communicate with the virtual vehicle to receive the simulated, vehicle-specific vehicle data therefrom and generate a student input signal representative of a student diagnostic decision. An instructor controller is disposable in communication with the virtual vehicle and the student workstation, with the instructor controller being configured to provide instructor input regarding the desired set of simulated, vehicle-specific vehicle data and review the student input.

### BACKGROUND

### 1. Technical Field

The present disclosure relates generally to automotive diagnostics, and more specifically, to a training system capable of simulating vehicle-specific data for use in an instructional environment that allows for viewing, by an instructor, of diagnostic decisions made by a student.

### 2. Description of the Related Art

The integration of computer systems into the automobile has resulted in automotive diagnostics including a data analysis component. In this regard, while historical vehicle diagnostics may have relied solely on a mechanic's assessment of what can be seen or heard during operation of the vehicle, the data provided by the contemporary vehicles allows for a much more comprehensive diagnostic assessment of the vehicle.

The large number of digital components found on modern vehicles may create a significant amount of data that may be analyzed when trying to diagnose a problem on a vehicle. As such, there may be difficulties in trying to parse through all of the data, especially for someone who lacks familiarity and expertise with the vehicle, such as do-it-yourself vehicle owners, and inexperienced vehicle technicians.

In view of the complexities associated with modern vehicle diagnostics, various diagnostic devices and systems have been developed that provide diagnostic solutions with minimal user input. Oftentimes, such devices rely on the existence of a historical database with vehicle data matched with possible solutions in similar vehicles. The effectiveness of the historical database may depend on the database having similar vehicle data to that received from the vehicle under test, in a vehicle sharing common characteristics (such as year, make, model, and engine), and that the similar vehicle data is matched with a possible solution. For instance, if the vehicle under test is a 2023 HONDA ACCORD, and the retrieved vehicle data includes a set of three diagnostic trouble codes (e.g. codes 1, 2, and 3), that data will be compared to data in the database to try and identify a possible diagnostic solution. However, the 2023 model year may be so new that the database has limited data for a 2023 HONDA ACCORD, with the limited data not including the combination of codes 1, 2, and 3. As such, the historical database may be of limited assistance in providing a possible diagnostic solution in such a situation. Thus, when the data in the historical database does not match with the data retrieved from the vehicle, or there is not a strong enough correlation between the historical data and retrieved data to have confidence in a possible diagnostic solution, other diagnostic processes may be required, which may have more reliance on the skill and knowledge of the technician.

Accordingly, there is a need in the art for a training system that allows for training system that allows students to become familiar with automotive diagnostic tools and strategies. Various aspects of the present disclosure address this particular need, as will be discussed in more detail below.

### BRIEF SUMMARY

In accordance with one embodiment of the present disclosure, there is provided an automotive diagnostic digital training method for teaching a student how to diagnose an actual vehicle through the use of a learning system configured to present selectable virtual vehicles having diagnostic systems corresponding to the actual vehicle and gauging the student's ability to diagnose a specified diagnostic condition on the virtual vehicle. The method includes configuring the virtual vehicle to simulate diagnostic systems of the actual vehicle, as well as simulating the specified diagnostic condition. A student workstation is enabled to access the virtual vehicle in a manner to simulate accessing the diagnostic systems of the actual vehicle, as well as to access the diagnostic systems of the virtual vehicle for retrieving simulated vehicle data therefrom to allow troubleshooting of the virtual vehicle. The student's ability to diagnose the diagnostic condition is evaluated based on the student's access of the diagnostic systems and use of the simulated vehicle data received from the diagnostic systems.

The virtual vehicle may include a virtual diagnostic port, and the step of enabling a student workstation to access the virtual vehicle may include accessing diagnostic system through the virtual diagnostic port.

The step of configuring the virtual vehicle may include configuring the virtual vehicle to include a communication architecture that is similar to that of the actual vehicle.

The diagnostic systems may include multiple levels, and the step of enabling the student workstation to access the diagnostic systems may include enabling access to the multiple levels. The access to multiple levels may including accessing a virtual electronic control unit (ECU) at a first level, and accessing a virtual sensor at a second level.

The step of configuring the virtual vehicle may include configuring the virtual vehicle to simulate diagnostic tools used in vehicle diagnostics. The diagnostics tools may include a battery tester.

The step of configuring the virtual vehicle may include configuring the virtual vehicle to simulate execution of a Special Function test.

The method may also include the step of enabling a teacher workstation to facilitate tracking of the student's efforts in troubleshooting of the virtual vehicle.

The step of evaluating the student's ability may include identifying at least one diagnostic condition the student fails to diagnose according to a prescribed metric. The prescribed metric may include identifying a prescribed replacement part, or identifying a prescribed diagnosis within a prescribed period of time.

The step of configuring the virtual vehicle to simulate the specified diagnostic condition may be based on an evaluation of prior diagnostic efforts of the student.

The method may include the step of assigning a score to the student's ability to diagnose the diagnostic condition based upon a comparison of a diagnostic process adopted by the student and a predetermined diagnostic process.

The method may include monitoring a diagnostic process adopted by the student. The method may include the step of identifying portions of the diagnostic process that deviate from a preferred diagnostic process. The preferred diagnostic process may be vehicle-specific. The portions of the diagnostic process that deviate from the preferred diagnostic process may include a request for sensor data.

The method may include displaying a configuration of the diagnostic systems of the virtual vehicle.

The method may comprise enabling display of data from multiple data sources on the student workstation. The data source may include an automotive reference manual.

The step of configuring the virtual vehicle may include connecting a physical vehicle input component to a physical vehicle electronic control unit (ECU). The physical vehicle input may be a physical vehicle sensor.

The method may also include the step of connecting a main controller operatively between the physical vehicle input component and the physical vehicle ECU, with the main controller being configured to facilitate communication between the physical vehicle input component and the physical vehicle ECU. The step of configuring the virtual vehicle to simulate the specified vehicle condition may include receiving a desired condition signal at the main controller from an instructor device.

The step of enabling a student workstation may include facilitating connection between a student device and the physical vehicle ECU.

The step of configuring the virtual vehicle may include connecting a physical vehicle electronic control unit (ECU) to a plurality of light emitting devices, each light emitting device being associated with a respective one of a vehicle input component and a vehicle output component.

According to another embodiment, an automotive diagnostic digital training method includes receiving input from an instructor regarding a desired set of vehicle-specific simulated vehicle data stored on a simulated data database. The simulated data database is accessed to retrieve the desired set of simulated vehicle data, and the desired simulated vehicle data is transmitted to a student workstation. The method additionally includes receiving student input regarding proposed diagnostic steps responsive to the desired simulated vehicle data, and displaying the received student input on a display for viewing by the instructor.

The student input may include a request for additional simulated vehicle data from the simulated data database. The student input may include a request to run a special function test. The method may additionally comprise communicating results from a simulated special function test in response to receipt of the request to run the special function test.

The desired set of simulated vehicle data may be selected from the list comprising: vehicle identification information, diagnostic trouble codes, live data, technical service bulletins, service manual information. The simulated vehicle data may also be associated with simulated bi-directional control, active actuator tests, and/or service reset functions.

The received student input may include a signal from a handheld diagnostic device. The received student input may be in OBD-II format.

The method may also include the step of comparing the received student input with a stored answer. A first response may be generated when the received student input corresponds to the stored answer and a second response may be generated when the received student input does not correspond to the stored answer. A student score may be generated based on the comparison of the received student input with the stored answer.

The method may include the step of communicating instructor feedback responsive to the student input to the student workstation.

The instructor may include an algorithm having preprogrammed instructions for providing instructor related input.

The instructor may include a processor having machine-learning capabilities adapted to provide instructor related input.

The desired set of set of vehicle-specific simulated vehicle data may include a pre-programmed test case having vehicle data associated with a preferred diagnostic sequence. The pre-programmed test case may be segregated into a plurality of selectable segments, and the input from the instructor may include selection of one of the plurality of selectable segments.

The method may further include comparing student input with preferred student input, and selecting simulated vehicle data based on the comparison of student input with preferred student input.

The method may additionally include sending a signal to a real vehicle corresponding to the desired set of simulated vehicle data. The real vehicle may be a real vehicle specifically configured for practice, training, or other teaching purposes.

According to another embodiment, there is provided an automotive diagnostic digital training system comprising a virtual vehicle including a data simulating processor and a database in communication with the data simulating processor and having simulated, vehicle-specific vehicle data stored thereon. The data simulating processor is configured to access simulated vehicle data stored on the database and generate a signal including a desired set of simulated vehicle data. A student workstation is disposable in communication with the virtual vehicle. The student workstation includes a handheld diagnostic device configured to communicate with the virtual vehicle to receive the simulated, vehicle-specific vehicle data therefrom and generate a student input signal representative of a student diagnostic decision. An instructor controller is disposable in communication with the virtual vehicle and the student workstation, with the instructor controller being configured to provide instructor input regarding the desired set of simulated, vehicle-specific vehicle data and review the student input.

The student input signal may include a request for additional simulated vehicle data from the simulated data database. The student input signal may include a request to run a special function test. The virtual vehicle may be configured to communicate results from a simulated special function test in response to receipt of the request to run the special function test, with the results of the simulated special function test being communicated from the database.

The student input may be in OBD-II format.

The instructor controller may include an algorithm having preprogrammed instructions for providing instructor related input. The instructor controller may include a processor having machine-learning capabilities adapted to provide instructor related input.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic overview of a virtual automotive diagnostic training system;

FIG. 2 is an exemplary flow chart of a methodology associated with the virtual automotive diagnostic training system;

FIG. 3 is a system level overview of one implementation of the virtual automotive diagnostic training system;

FIG. 3A depicts a first portion of the virtual automotive diagnostic training system of FIG. 3;

FIG. 3B depicts a second portion of the virtual automotive diagnostic training system of FIG. 3;

FIG. 4 is an example of a training system having the capability of transferring training data for diagnostics on a real vehicle;

FIG. 5 is a flow chart of a method associated with the training system of FIG. 4;

FIG. 6 is an embodiment of an automotive diagnostic training system configured to utilize physical vehicle components in a virtual vehicle;

FIG. 7 is a schematic view of illustrating ability of an instructional device to access a virtual vehicle, facilitate lessons and facilitate testing;

FIG. 8 is a schematic view of the instructional device being operated in an OBD mode;

FIG. 9 is a schematic view of the instructional device being operated in a control mode; and

FIG. 10 is a schematic view of a virtual component board having a plurality of LEDs, each LED being associated with a respective vehicle input component or a vehicle output component, the virtual component board being connectable to a physical vehicle ECU.

Common reference numerals are used throughout the drawings and the detailed description to indicate the same elements.

### DETAILED DESCRIPTION

The detailed description set forth below in connection with the appended drawings is intended as a description of certain embodiments of a digital automotive diagnostic training system and method and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to an automotive diagnostic digital training system adapted to present vehicle-specific, simulated vehicle data to a student to allow the student to perform simulated diagnostics on the data as a learning tool. The system may include a database of simulated vehicle data, with the database being in operative communication with an instructor workstation and a student workstation. The instructor may access select portions of the database to configure a virtual vehicle that may be diagnostically tested by the student. The system may allow the instructor to oversee the decisions and actions being performed by the student, even if the instructor and student are remote from each other, which allows for instructor guidance and feedback throughout the process. Furthermore, the system may be adapted to allow an instructor to focus on certain segments of a diagnostic process that may be difficult or overlooked by some students, in order to more efficiently train difficult diagnostic situations. The system may be configured to allow use of conventional diagnostic hardware by the students to foster familiarity with the equipment. The simulated nature of the training system enables students to learn and make mistakes when working on simulated cases, rather than working on real vehicles. Thus, once the student has gained sufficient knowledge to graduate from a simulated environment to a real-world environment, the student will have already gained a baseline level of knowledge to be a productive member of an automotive diagnostics team.

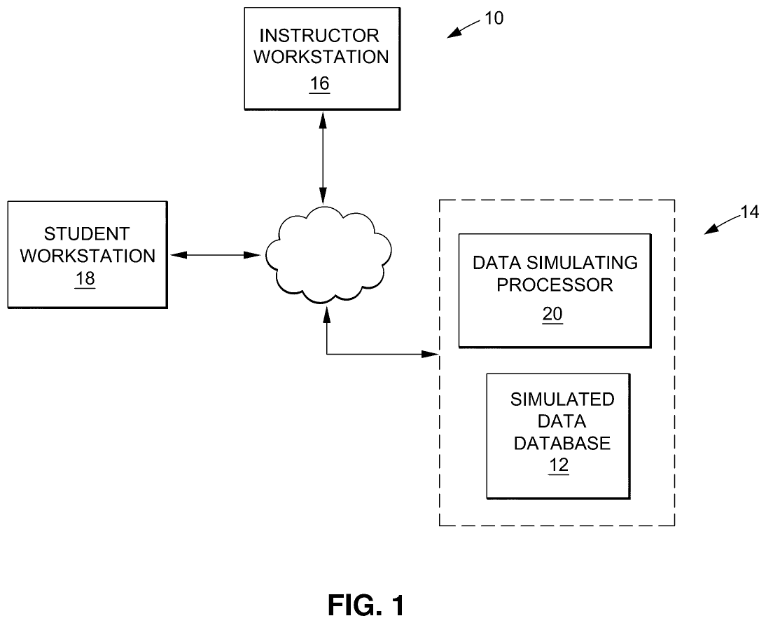

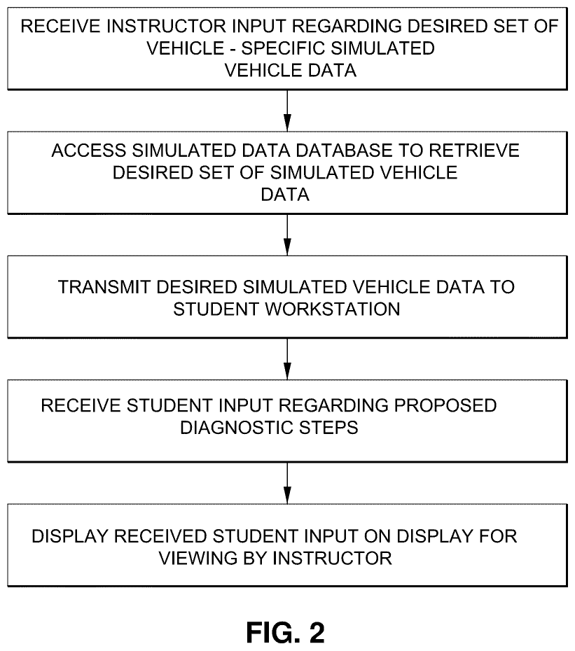

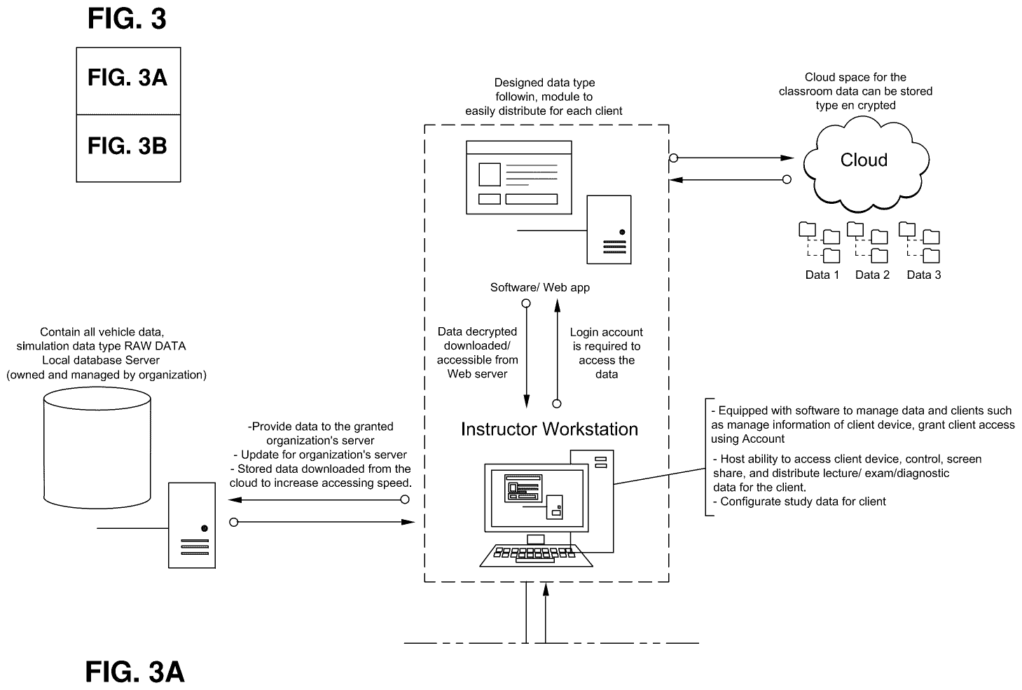

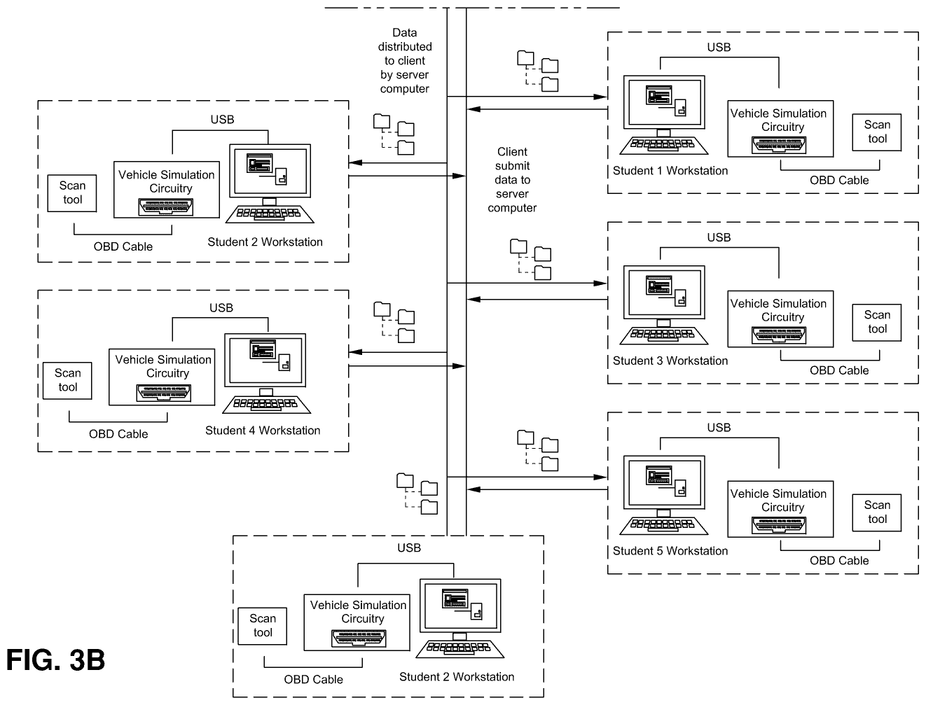

Referring now to the drawings wherein the showings are for purposes of illustrating a preferred embodiment of the present disclosure, and is not for purposes of limiting the same, FIG. 1 depicts an exemplary training system 10 including a database 12 having simulated data for use in testing a virtual vehicle 14, an instructor workstation/controller 16, and one or more student workstations 18. Each system component will be described in more detail below.

### Virtual Vehicle

According to one embodiment, the virtual vehicle 14 may include simulated vehicle data and computer hardware capable of generating vehicle-specific data representative of an actual vehicle selected by one of the instructor or the student. The virtual vehicle 14 may be capable of simulating almost any operational condition of an actual vehicle, any test that can be implemented on a vehicle, any diagnostic condition experienced by a vehicle, etc. In this regard, from the standpoint of the person receiving the simulated data, the data from the virtual vehicle 14 may be indiscernible from that of a real vehicle.

The virtual vehicle 14 may include a database 12 of simulated vehicle data and a data simulating processor 20 in operative communication with the database 12. The database 12 may include vehicle identification information (e.g., year, make, model, engine), diagnostic trouble codes, live data, technical service bulletins, and service manual information, simulated sensor data, test results (e.g., Special Function tests), or other data, results, or information retrievable, accessible or otherwise available from a real vehicle. For more information regarding the use of Special Function tests, please refer to U.S. patent application Ser. No. 18/328,289, entitled SYSTEM AND METHOD FOR GUIDED VEHICLE DIAGNOSTICS, filed on Jun. 2, 2023, the contents of which are expressly incorporated herein by reference. The database 12 may be arranged or indexed by vehicle identification information to allow for simulated diagnostics on specific vehicles. For instance, an instructor may conduct a first simulated diagnostics exercise on a first vehicle (e.g., a 2004 HONDA ACCORD), and a second simulated diagnostics exercise on a second vehicle (e.g., a 2023 BMW X5). Thus, an initial step in a training session may include identifying the vehicle identification information for the simulated vehicle. Once the vehicle identification information is known, the vehicle data stored in the database 12 and matched with the identified vehicle identification information may accessed and used for the virtual training for that particular vehicle.

The virtual vehicle 14 may be selectively configurable to simulate diagnostic systems of an actual vehicle, as well as to simulate a specified diagnostic condition on the virtual vehicle. The configuration of the virtual vehicle 14 may entail use of the data simulating processor 20, which is configured to access simulated vehicle data stored on the database 12 and generate a signal including a desired set of simulated vehicle data. Thus, the data simulating processor 20 may receive signals from an instructor workstation 16, as well as a student workstation 18, and access the database 12 to retrieve the requested data, and communicate the requested data to the appropriate destination. The data simulating processor 16 may include, or be in operative communication with, a memory circuit to enable short-term memory storage of relevant information needed to implement the training functionality. For instance, the memory circuit may retain the vehicle identification information for a given training session to enable retrieval of data associated with that vehicle identification information during the training session.

The virtual vehicle 14 may also be configured to include a communication architecture similar to that of the actual vehicle. For instance, if the actual vehicle has a diagnostic port, a number of ECUs, electrical systems, primary communication pathways in which data is communicated in one communication protocol and secondary communication pathways in which data is communicated in another communication protocol, the virtual vehicle 14 may be configured to mimic such a communication architecture. For instance, the virtual vehicle 14 may include a virtual diagnostic port, a number of virtual ECUs, virtual electrical systems, virtual primary communication pathways in which data is communicated in one communication protocol and virtual secondary communication pathways in which data is communicated in another communication protocol. Thus, if a student is using a training tool having limited communication capabilities, the student may be denied access to certain areas of the virtual vehicle's electrical system. Such a restriction may impress upon the student the importance of knowing the capabilities of the tool he may be using (e.g., a basic tool versus a sophisticated tool) to develop diagnostic methodologies that are implementable by the tool.

The database 12 may also be arranged with various test cases already pre-programmed into the database 12. In this regard, each test case may be associated with a specific vehicle identification information, and may include operational data, diagnostic data, test data, sensor data, etc. The data associated with the test case may also be organized based on an anticipated diagnostic sequence being made by the student. For instance, it may be anticipated that the student's initial inquiry will be for the vehicle identification information, in which case, the virtual vehicle 14 may respond with vehicle identification information. It may be anticipated that the student's second inquiry will be for first level diagnostic data, which may include a set of DTCs and associated freeze frame data, and which may be provided by the virtual vehicle 14. The student's third inquiry may go in several different directions. For instance, the student may ask for specific live data, sensor data, system data, monitor status, implementation of a specific test, etc. In one embodiment, the virtual vehicle 14 provides available virtual data responsive to the student's request. However, in other embodiments, the virtual vehicle 14 may be configured to guide the student down a desired diagnostic path (e.g., a preferred diagnostic process), and if the student deviates from the desired path, the virtual vehicle 14 may send an alert to one or both of the student and/or the instructor. The desired diagnostic path may include a desired, step-by-step diagnostic sequence, or alternatively, a desired general sequence, that may be used as a reference for comparison to the student's adopted diagnostic path or sequence. For instance, if the preferred path is for the student to request live data in the third inquiry, but the student request implementation of a specific test, the virtual vehicle 14 may alert the instructor and/or the student of the incorrect inquiry. The instructor may be able to contact the student to provide guidance to the student, and use the deviation from the preferred diagnostic path as a teaching moment.

The test cases may be pre-programmed test cases, or alternatively, it is contemplated that the virtual vehicle 14 may be configured to allow an instructor to build a customized test case. Thus, the instructor may define the test case with specific vehicle identification information as well as specific diagnostic data, and a desired diagnostic sequence. The alerts provided by the virtual vehicle 14 may also be customizable by the instructor.

It is also contemplated that the student's performance may be stored or tracked to identify strengths and weaknesses of the student. For instance, the student's performance may reveal that the student is weak in diagnosing issues on certain makes of vehicle, or in identifying certain diagnostic conditions. Such weakness may be defined by the student deviating from a desired diagnostic path, taking too long to reach a preferred diagnostic conclusion, making wrong diagnostic decisions a defined number/percentage of the time, or some other variable that may be set by the operator of the system 10. If a weakness is defined, the virtual vehicle 14 may provide test cases that emphasize the student's weakness to allow the student to hone the skills needed to overcome that weakness. As such, some or all test cases may be associated with certain diagnostic characteristics that may be used to identify the test cases for use by a student needing work on a particular weakness. For instance, if the student shows a weakness in using monitor status that may be critical in particular diagnostic processes, various test cases that may be tagged or otherwise associated with monitor status criticality may be identified and uploaded for use by such student. The identification of the test cases may be done by the instructor by searching for particular tags or characteristics in the test cases, or by a computer program capable of using the student's identified weakness as the driver/guide in a search for test cases. As such, the system 10 may allow for instructor-guided searches for test cases, as well as computer-driven (e.g., autonomous) searches for test cases. In this regard, machine-learning/artificial intelligence resources may be used to monitor student performance and recommend future test cases based on the student's monitored performance. It is also contemplated that a student may be capable of searching a library of test cases using search terms associated with the desired test cases to identify test cases that may focus on desired diagnostic characteristics.

### Student Workstation

Each student workstation 18 may be disposable in communication with the virtual vehicle 14. The student workstation 18 may include a computer terminal and a handheld diagnostic device configured to be enabled to communicate with the virtual vehicle 14 via the computer terminal. In this regard, the computer terminal may be capable of communicating with virtual vehicle 14, regardless of whether the virtual vehicle 14 is local or remote. As such, the computer terminal may include a communication circuit capable of short-range communications (e.g., wired or wireless such as BLUETOOTH) or long-range communications, such as via a cellular network, the internet, or the cloud. In some embodiments, it is contemplated that the handheld diagnostic device may include the communication capability, and thus, a separate computer terminal may not be needed.

The handheld diagnostic device may include, or take the form of, a conventional scan tool, code reader, dongle, diagnostic tablet, etc. The handheld diagnostic device may include diagnostic devices that may be used in the field, on real vehicles. Or alternatively, the handheld diagnostic device may specifically designed as a training device, and may not be capable of communicating with an actual vehicle.

The handheld diagnostic device may include an OBD-II connector, or a connector configured similar to a conventional OBD-II connector, that may be plug connectable to a corresponding connector port formed on the computer terminal. In this regard, connecting the handheld diagnostic device to the computer terminal may be similar to connecting the handheld diagnostic device to a vehicle connector port.

The student may enter student input signals, either into the handheld diagnostic device or the computer terminal, during a training session. The student input signal may include signals associated with the student initially creating a user profile and setting up user-specific preferences, as well as signals associated with the diagnostic process.

It is contemplated that in some embodiments, the student may be able to simulate one or more components on the virtual vehicle to try and pinpoint the system/component that may be the root cause of the diagnostic condition. For instance, the student may be able to configure a component on the virtual vehicle to supply data that is known to be either good or bad, to see how the overall data returned from the vehicle reacts to that change. For instance, the student may modify the data associated with the fuel pump, such that in one instance, the student configures the fuel pump to supply optimal data to the virtual vehicle system, and in another instance, configures the fuel pump to supply bad data to the virtual vehicle system. An expected reaction would be the fuel-pump related systems and data to deviate from healthy data as the fuel-pump data is changed from good data to bad data. However, if the fuel-pump related data does not change (i.e., such data is bad in both instances or good in both instances), then there may be a problem elsewhere, and thus, the student may be able to eliminate the fuel-pump as a root cause of the diagnostic condition.

### Instructor Controller

An instructor controller/workstation 16 is disposable in communication with the virtual vehicle 14 and the student workstation 18. The instructor controller 16 is configured to provide instructor input regarding the desired set of simulated vehicle data and review the student input. The hardware included in the instructor controller 16 may include an instructor input device, such as a keyboard, touch screen monitor, instructor controlled handheld diagnostic device, camera, microphone, etc. A monitor or display, as well as speakers, may be included in the instructor controller 16 to allow for viewing of the students diagnostic decisions and listening to the student's commentary. In this regard, the student's inputs may not only go to the virtual vehicle 14, as described in more detail above, the student's input may also go to the instructor controller 16.

As discussed above, the instructor may be capable of selecting preprogrammed training cases having vehicle data (e.g., DTCs, live data, sensor data, testing data, monitor status, drive cycle information, etc.) matched to a specific vehicle/vehicle identification information. The instructor may be capable of identifying available test cases for a particular vehicle by entering in vehicle identification information for the vehicle. For instance, the test cases for a given year, make, model, and/or engine may be identified. A specific test case may be selected by the instructor by the instructor making an entry into the instructor controller 16 (e.g., selecting a specific test case from a drop down list of a plurality of available test cases), and in response thereto, the instructor controller 16 may be configured to generate a test case selection signal, which may be transmitted to the virtual vehicle 14. Upon receipt of the test case selection signal, the virtual vehicle 14 may be configured to send the test case to the student workstation 18 for simulated diagnostics by the student. The instructor may be able to monitor the activities of the user through the operative communication between the instructor, student, and virtual vehicle 14.

It is contemplated that the test cases may be configured to allow the instructor and/or the student to request training on a specific portion of a pre-programmed test case. In this regard, the test cases may be segregated into selectable portions, which may be selectable by the instructor and/or student. For instance, an exemplary test case, from beginning to end along a preferred diagnostic sequence, may be segregated into five segments. The instructor may be capable of starting the test case on the third segment, such that the student works on the third, fourth, and fifth segments, or alternatively, only the third segment.

In certain embodiments, the instructor controller may be configured to be operable by a virtual instructor, i.e., an algorithm, or a computer having machine-learning capabilities. In this regard, the virtual instructor may guide the training session of the student based on rules set forth in the algorithm, or based on learned characteristics developed over time by a machine-learning computer that monitors live instructors.

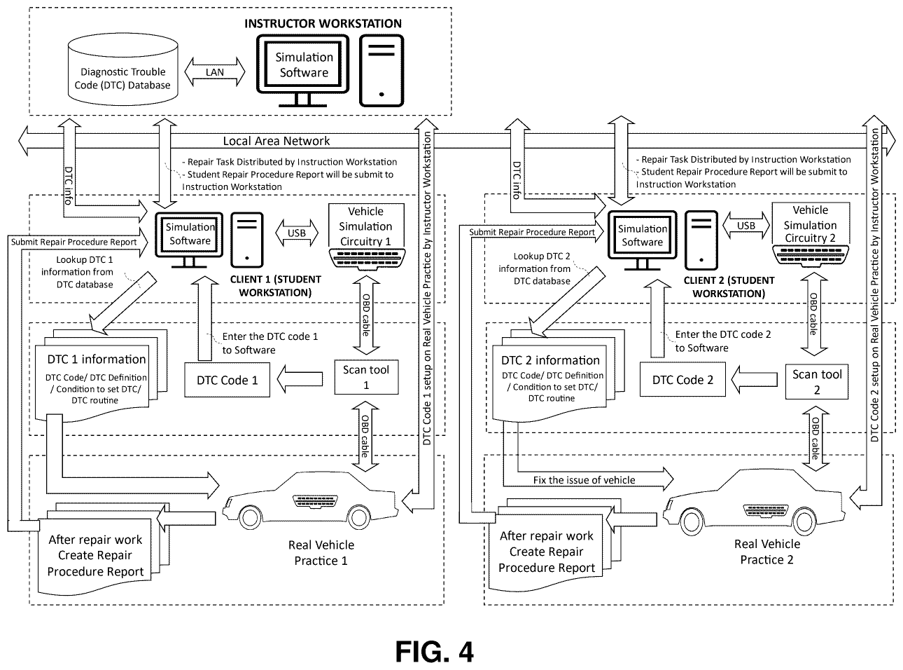

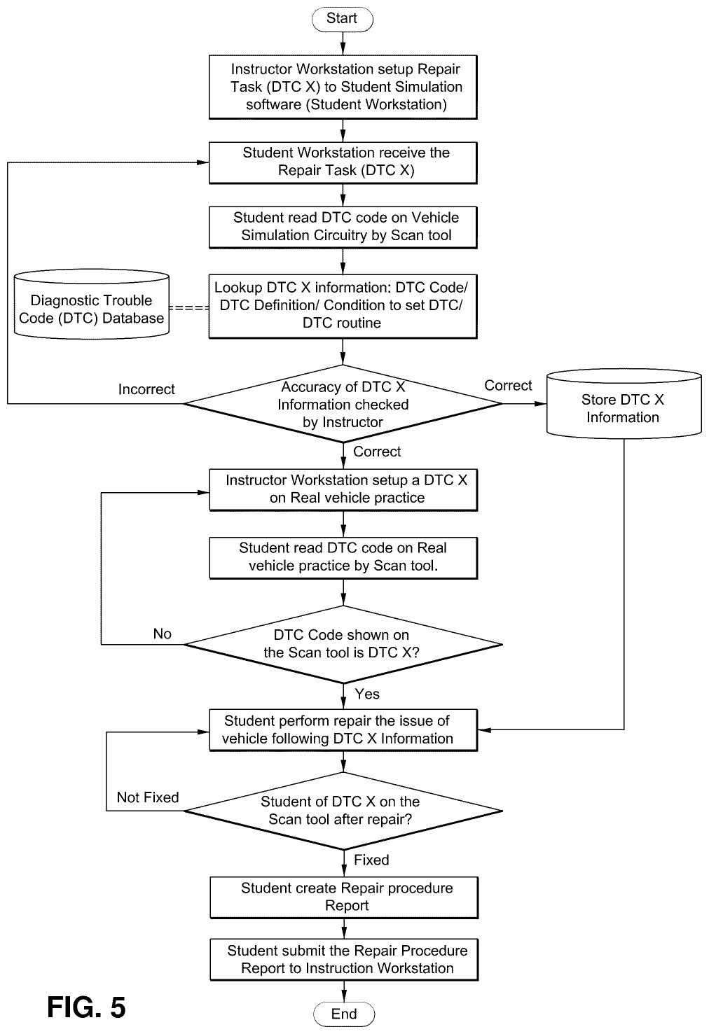

According to one embodiment, and referring now specifically to FIGS. 4 and 5, it is contemplated that the system 10 may be configured to allow a student to perform on a simulated diagnostics for specific vehicle data on the virtual vehicle 14, and then subsequently perform the real diagnostics for the same vehicle data on a real vehicle. For instance, an instructor may be configure the virtual vehicle 14 to include DTC X. The student may connect to the virtual vehicle 14 using the handheld diagnostic device, retrieve DTC X, and perform a virtual diagnostic procedure to address DTC X. Thereafter, the instructor may transfer DTC X to a real vehicle, and have the student perform the diagnostics on the real vehicle. While there may be no difference between the diagnostic procedures for the virtual vehicle 14 and the real vehicle, the ability to perform the diagnostics on the real vehicle may build confidence in the student.

The system 10 may be able to track the student's activities/communications with the real vehicle, and compare those activities/communications with the previously diagnostic virtual vehicle 14. If the student's activities/communications relative to the real vehicle deviate from the activities/communication relative to the virtual vehicle 14, the system 10 may generate an alert to the student and/or the instructor via their respective workstations or devices. As such, a monitoring circuit may be in communication with the student device and the instructor device to implement the above-described functionalities.

### Simulation Using Actual Vehicle Components

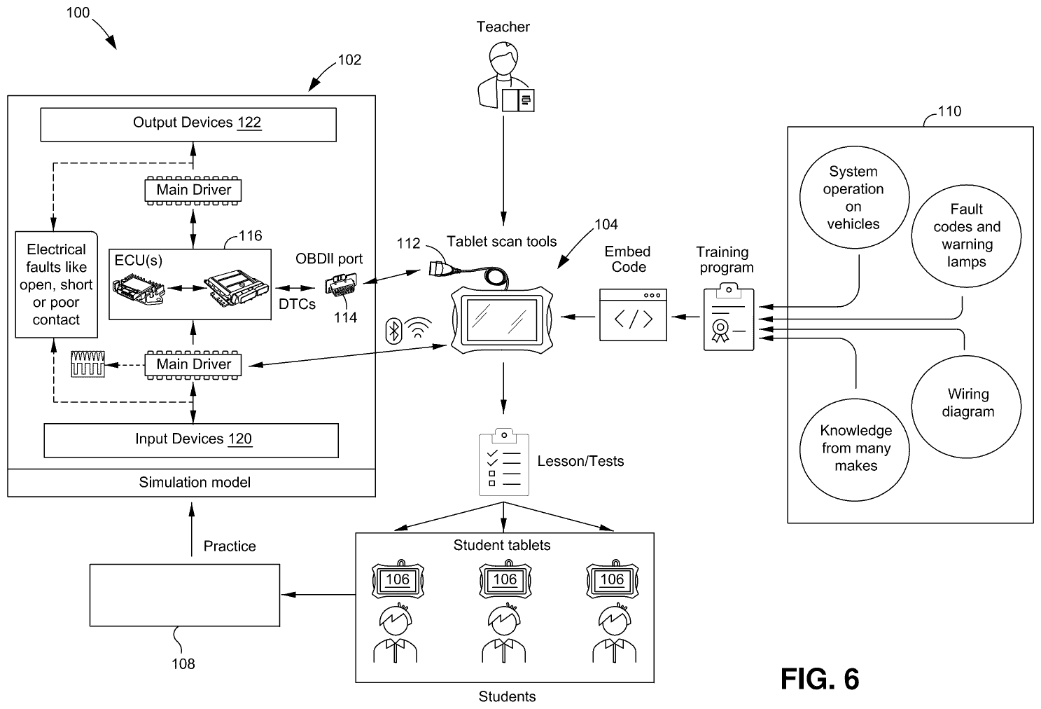

In addition to the foregoing, and referring now specifically to FIGS. 6-10, it is contemplated that in other embodiments, the virtual vehicle may be comprised of using real, physical vehicle components for use in an instructional setting. For instance, the virtual vehicle may include a real electronic control unit (ECU) from an actual vehicle, simulating electrical signals to mimic sensor signals (input signals to the ECU), and using valves, motors, LED lights, etc., to replace valves, motors, and mechanisms on the actual vehicle (output signals from the ECU).

Referring now specifically to FIG. 6, there is depicted an instructional system 100 generally including a virtual vehicle 102, a teacher device 104, a plurality of student devices 106 and related student tools 108 and a database 110 of virtual vehicle characteristics that may be used in the educational process. In the exemplary embodiment, the teacher device 104 and the student device 106 is a tablet scan tool, although it is contemplated that other hardware may be used as the teacher/student workstations/devices 104, 106, including other scan tools, code readers, diagnostic dongles, or any other hardware currently known or later developed that facilitates communication with an ECU, either directly through wireless communication, or via communication through a diagnostic port (e.g., a OBD-II port).

The tablet scan tool 104, 106 may include a diagnostic connector 112 connectable to an actual diagnostic port 114, which is in communication with one or more physical ECU(s) 116. The physical ECU(s) 116 may be associated with a particular year, make, model, engine of a particular vehicle, or alternatively, the ECU(s) 116 may be programmed to be more universal in nature, and configurable to mimic a wide range of vehicles. The tablet scan tool 104, 106 may be configured to operate on various operating systems, such as iOS, Android, Linux, and the like. The teacher device 104 may include all lessons and tests, and may be configured to control other devices as well as store user information. In this regard, the teacher device 104 may include a memory circuit or other hardware (e.g., flash drive, RAM-memory, or other memory hardware) for storing the data, instructions, etc., associated with the lessons, tests, and other information. It is also contemplated that an external memory resource, such as a remote server, may store some or all of the foregoing data and information, and the teacher device 104 may selectively access such information as needed through communication between the teacher device 104 and the remote server. Teachers may use the tablet scan tool 104 to deliver lessons or practical exercises to students and can share the screen while teaching. With this model of operative communication between the teacher and student devices 104, 106, teachers can control students'practical learning or assessment time.

The student device 106 may include a similar tablet, or other hardware, which may be capable of accessing learning accounts associated with the students. A difference between the student device 106 and the teacher device 104 is that the student device 106 may be capable of viewing data and information, proceeding through lessons and tests, but cannot simulate a vehicle signal, or make selections as to the characteristics of the virtual vehicle 102. Such functionality may be reserved for the teacher device 102. However, in other embodiments, the student device 106 may be configured to access the virtual vehicle 102, either directly, or via the teacher device 104.

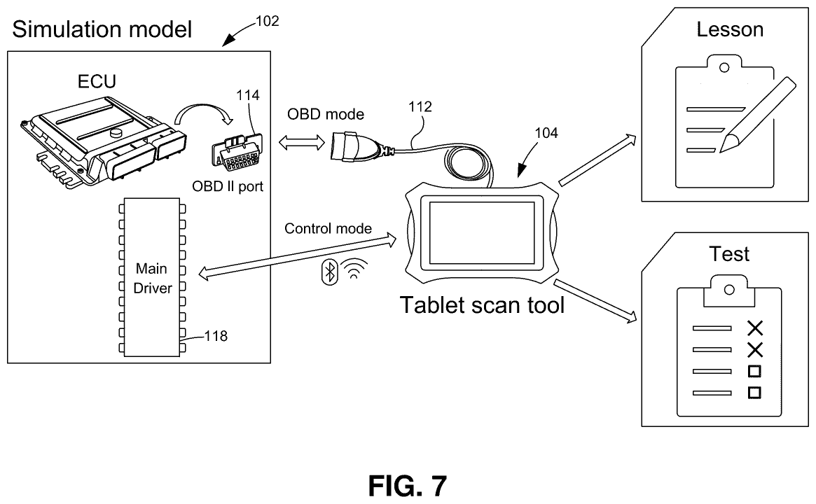

Referring now specifically to FIG. 7, in one embodiment, the teacher tablet scan tool 104 may be configured to operate in two main operational modes, namely, an OBD mode and a control mode. Through the OBD mode, the tablet 104 may connect to the virtual vehicle 102 via the OBDII port and communicates with the virtual vehicle 102 like a real vehicle. On the tablet screen, a user may be capable of viewing DTC error codes, dynamic data, generate and send commands to activate actuators such as lights, valves, motors, or other components included on the virtual vehicle 102. The control mode may be used when the teacher wants the students to practice on the model or perform practical tests on the model itself. The tablet 102 may send commands to a main controller 118, referred to in the drawings a main driver 118, via Bluetooth, Wi-Fi, or other forms of wireless or wired communication. The main controller 118 may receive the requests and operate the virtual vehicle 102 under the desired conditions of the user. To enhance the realism of the virtual vehicle 102, the main driver 118 may autonomously generate faults such as short circuits, open circuits, or poor contacts in the electrical circuits of input and output signals. Consequently, the ECU 116 may establish error codes and corresponding data, which may be displayed to the user using the tablet scan tool 104, 106. The controllers 118 may facilitate directional communication between the ECU 116 and the input vehicle components 120, as well as the ECU 116 and the output vehicle components 122.

The simulation model/virtual vehicle 102 may be configured to simulate one system or several combined systems to help students understand the operating principles of those systems. However, a model that meets all the real-life conditions like a real car and can change operating modes, adjust input parameters, or generate faults in the system has not yet truly emerged. Furthermore, a model combined with a tablet or control device, integrating testing and practical exercises directly on the model closely related to theoretical lessons provides a unique vehicle diagnostic teaching system.

The simulation models/virtual vehicles 102 may simulate one or more systems from a real vehicle (any brand), using a separate controller/main driver 118 to simulate input signals (usually sensors or switches) to the ECU 116 as if the ECU 116 were installed on a real car. The vehicle's ECU 116 processes the received input signals and generates a control voltage to the output devices 122 on the virtual vehicle 102 (e.g., valves, motors, lights, etc.). A main driver 118 may be operatively disposed between the input components 120 and the ECU 116 to facilitate communication between the input components 120 and the ECU 116. In this regard, the main driver 118 may be configured to function similar to a communication bus on an actual vehicle. A similar main driver 118 may also be operatively disposed between the ECU 116 and the output components 122. The main driver 118 may provide input signals to the virtual vehicle's ECU 116 to make the virtual vehicle 102 behave like a real vehicle. Although FIGS. 6, 8, and 9 depict separate main drivers 118 between the ECU 116 and the input and output components 120, 122, it is contemplated that a single main driver 118 may be used between the ECU 116 and the input and output components 120, 122.

Diversity of virtual vehicles may be enhanced by simulating various systems from different vehicles. Each virtual vehicle may be assigned a unique ID stored in the main driver 118. When communicating with the software on the tablet 104, the program may generate corresponding practical lessons based on the ID. In this regard, the programs (e.g., lessons, tests, and other content) may be vehicle-specific.

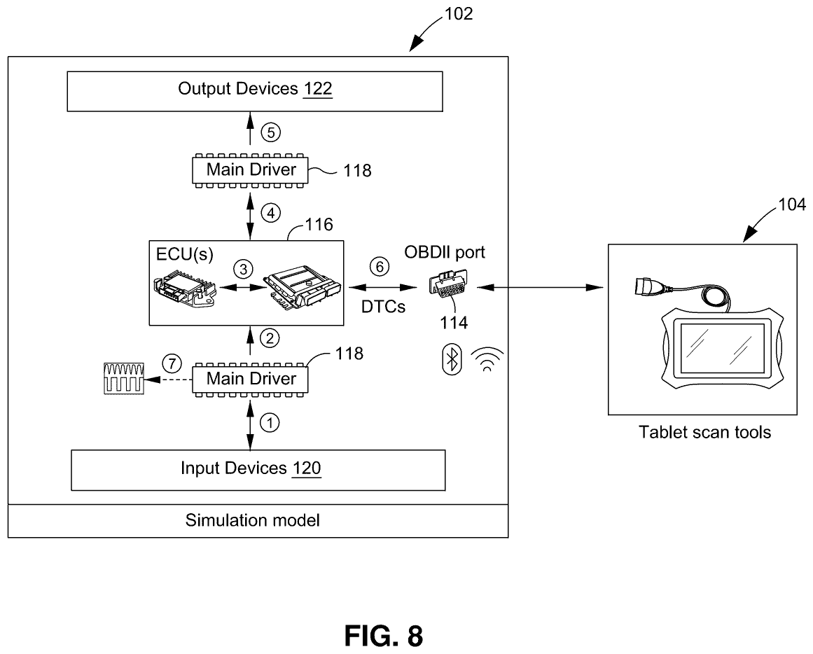

In more detail, the operational flow of the OBD mode depicted in FIG. 8 is as follows: (1) input signals from sensors/input components 120 will be controlled, calculated, and processed appropriately by the main driver 118 to simulate real-world conditions. (2) The main driver 118 will deliver the input signals to the ECUs 116. (3) If there are multiple ECUs 116 in the model, they can communicate and exchange data with each other as in real vehicles. (4) The ECUs 116 will process the input signals and send control signals (e.g., output signals) to the actuators/output components 122. (5) The main driver 118 provides control signals from the ECUs 116 to the output components 122. (6) The ECUs 116 will send error code signals and data to the tablet scan tool 104 through the OBD 2 port. (7) Every signal that is simulated can also be displayed on an oscilloscope.

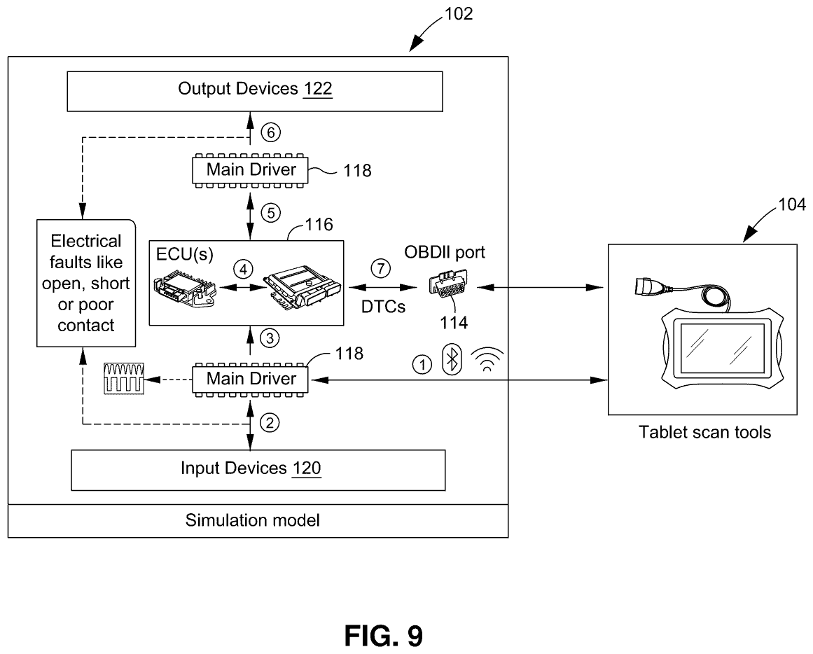

In the event the instructor wants to create a practical exercise or a comprehensive test on the model, the system may be configured to allow the instructor to switch the operating mode of the virtual vehicle 102 to a control mode, an example of which is depicted in FIG. 9. In more detail, the operational flow is as follows: (1) The Tablet scan tool sends a command to activate the control mode and requests the Main driver 118 to create corresponding operating conditions. These operating conditions could involve inducing a fault in a specific component. (2) Starting from the input signals, the Main driver 118 is tasked with altering these signals to generate abnormalities and supplies them to the ECU(s) 116; The Main driver 118 also generates electrical faults on sensors or inputs in general. (3) After processing, it promptly sends them to the ECU(s) 116. (4) If there are multiple ECUs 116 in the model, they can communicate and exchange data with each other as in real vehicles. (5) The ECU(s) 116 control the output components based on the input signals provided by the Main driver 118 and send control signal to outputs via main driver 118; In case the output signals are faulty (controlled by the main driver 118 in step (6)), the ECU(s) 116 can also recognize this as an input signal to set a fault code in its memory. (6) Main driver 118 directly controls the outputs, even creating electrical faults as command from user (7) The fault code (DTCs) information, live data are output to the tablet scan tool for display to the user via the OBD 2 port.

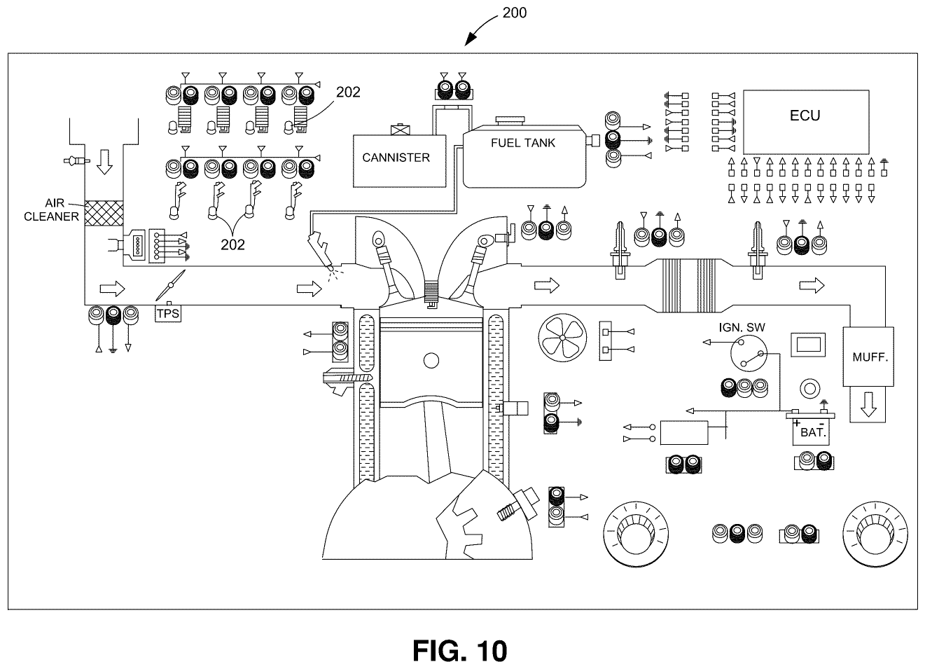

In certain situations, and referring now specifically to FIG. 10 it may be desirable to incorporate sensors and actuators (input and output devices) that are not actual components taken from the vehicle, but instead are electronic components or simpler parts. For example, fuel injectors and spark plugs may be replaced with LED lights. FIG. 10 shows a virtual vehicle, or a portion of a virtual vehicle including a panel 200 having LED lights 202 representative of the input and output devices. As such, when the ECU controls the injector or ignition, the LED lights 202 will blink according to the control signal. This may provide learners with a more visual understanding of the control signals while the system is operating. This may also help to minimize the costs of building the model while still ensuring its academic integrity.

Each student participating in the program may have an account with a unique ID. Students may use the unique ID to join theoretical classes, practical sessions, and take tests, all of which may be tracked based on the student's unique ID. The account also serves to track training results, evaluate students through each lesson.

Teachers may easily grasp the ability, progress, and understanding of their students through statistics from the system. While teaching, teachers can switch between the operational modes of the virtual vehicle, for example, by setting the engine to rotate at 2500 rpm and then back to idle speed. Thus, the virtual vehicle may be configurable to allow teachers to selectively modify the operational characteristics of the virtual vehicle. Teachers may also easily switch to the OBD mode to read DTCs, view live data of the system, and share their screen with students'tablets 106.

It is contemplated that in certain embodiments, the tablets 104, 106 may be configured to operate in the OBD mode on real vehicles by plugging the diagnostic connector 112 into the diagnostic port on the real vehicle and then bring the vehicle to the desired operating condition. The vehicle's data may be retrieved and displayed on the screen, and students may be able to directly observe this process.

The virtual vehicle may further be configured to include checkpoints on the virtual vehicle components for students to practice measuring and testing the system's operations. Skills in using devices such as multimeters, power checkers, pulse meters, wiring, etc., may be developed through direct practice on the virtual vehicle. In this regard, the virtual vehicle may include physical contacts or other connections intended to allow for operative interaction with such components. The virtual vehicle may generate signals that are transmittable through those connections, with the signals being representative of different readings detectable or readable through the additional components, which allows the students to develop the skills in using the additional components in the diagnostic process.

The instructional system may be configured to service multiple levels of learners, with detailed lessons, and pre-programmed diagnostic tests or conditions for each level. When wanting to advance to a higher level, a teacher or trainer may use a competency assessment function within the instructional system to evaluate the learners. A test comprising theoretical and practical components may be provided and transmitted student workstation(s)/tablet(s) 106 for them to understand their own test section clearly. The practical assessment may be conducted directly on the virtual vehicle 102. After receiving a request for a test mode, the instructional system may generate its own fault conditions on the hardware associated with the virtual vehicle 102. Learners may apply measurement skills and knowledge to identify faults, determine causes of malfunctions, and enter answers into their tablets 106. The test may conclude with the application scoring and providing results to both teacher/trainer and learners. The scoring may entail an analysis of several factors, such as: 1) comparison of the student's diagnostic procedure with an expected diagnostic procedure; 2) comparison of the student's duration in proceeding through the diagnostic process with an expected duration in proceeding through the diagnostic process; and/or 3) comparison with a student's diagnostic conclusions with expected conclusions. It is contemplated that one or more factors may be disregarded when completing the scoring. For instance, some instructional settings may not factor in the time it took the student to form a diagnostic conclusion. It is also contemplated that the factors may be selectively assigned different weights depending on whether the administrator of the test wants to emphasize one or more factors, while diminishing the influence of another factor(s) on the overall score.

The integrated training program may ensure comprehensive knowledge from basic to advanced, covering theory to practice for learners. Integrated with diagnostic features, the training program may facilitate easier and more realistic learning. The diagnostic functionality that may be implemented by the training program may include, but is not necessarily limited to error reading, error clearing, dynamic data viewing, activation, adjusting actuators, helping learners work more visually with the model.

The educational program may be developed specifically for learners in the automotive diagnostic field. It is designed to encompass a comprehensive range of knowledge, from basic electronics and electronic components to their application in vehicles. Understanding the principles of electrical systems in vehicles is also an integral part of the curriculum. Furthermore, advanced diagnostic skills such as error code interpretation, live data analysis, actuator activation, ECU calibration, etc., may be facilitated by the instructional system.

The instructional system may further include a well-balanced mix of meticulously designed lessons to facilitate swift comprehension and long-term retention of knowledge. The program may be structured into multiple levels of study, with each lesson tailored to the curriculum of its respective level. The tests and practical exercises for each level are accordingly varied.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An automotive diagnostic digital training method for teaching a student how to diagnose an actual vehicle through the use of a learning system configured to present selectable virtual vehicles having diagnostic systems corresponding to the actual vehicle and gauging the student's ability to diagnose a specified diagnostic condition on a selected virtual vehicle, the method comprising the steps of:
configuring the selected virtual vehicle to simulate one or more specified diagnostic systems of the actual vehicle;
configuring the selected virtual vehicle to simulate the specified diagnostic condition;
enabling a student workstation to access the selected virtual vehicle in a manner to simulate accessing the diagnostic systems of the actual vehicle;
enabling the student workstation to access the specified diagnostic systems of the virtual vehicle for retrieving simulated vehicle data therefrom to facilitate troubleshooting of the virtual vehicle; and
evaluating the student's ability to diagnose the specified diagnostic condition based on the student's interface with the selected diagnostic systems and analysis of the simulated vehicle data received from the selected diagnostic systems.

2. The automotive diagnostic digital training method recited in claim 1, wherein the virtual vehicle includes a virtual diagnostic port, the step of enabling a student workstation to access the virtual vehicle including enabling to the diagnostic system through the virtual diagnostic port.

3. The automotive diagnostic digital training method recited in claim 1, wherein the step of configuring the virtual vehicle includes configuring the virtual vehicle to simulate a communication architecture that is functionally similar to that of the actual vehicle.

4. The automotive diagnostic digital training method recited in claim 1, wherein the diagnostic systems includes multiple communication levels, each communication level requiring a different communication protocol, the step of enabling the student workstation to access the diagnostic systems includes enabling access to the multiple communication levels.

5. The automotive diagnostic digital training method recited in claim 4, wherein access to a virtual electronic control unit (ECU) includes enabling access to a first level, and access to a virtual sensor includes accessing a second level.

6. The automotive diagnostic digital training method recited in claim 1, further comprising the step of simulating at least one simulated diagnostic tool used in vehicle diagnostics, the at least one simulated diagnostic tool generated simulated vehicle data usable in diagnosing the virtual vehicle.

7. The automotive diagnostic digital training method recited in claim 6, wherein the diagnostics tools include a battery tester.

8. The automotive diagnostic digital training method recited in claim 1, wherein the step of configuring the virtual vehicle includes configuring the virtual vehicle to simulate execution of a Special Function test.

9. The automotive diagnostic digital training method recited in claim 1, further comprising the step of enabling a teacher workstation to facilitate tracking of the student's efforts in troubleshooting of the virtual vehicle.

10. The automotive diagnostic digital training method recited in claim 1, wherein the step of evaluating the student's ability includes identifying at least one diagnostic condition the student fails to diagnose according to a prescribed metric.

11. The automotive diagnostic digital training method recited in claim 10, wherein the prescribed metric includes identifying a prescribed replacement part.

12. The automotive diagnostic digital training method recited in claim 10, wherein the prescribed metric includes identifying a prescribed diagnosis within a prescribed period of time.

13. The automotive diagnostic digital training method recited in claim 1, wherein the step of configuring the virtual vehicle to simulate the specified diagnostic condition is based on an evaluation of prior diagnostic efforts of the student.

14. The automotive diagnostic digital training method recited in claim 1, further comprising the step of assigning a score to the student's ability to diagnose the diagnostic condition based upon a comparison of a diagnostic process adopted by the student and a predetermined diagnostic process.

15. The automotive diagnostic digital training method recited in claim 14, wherein the score is based on an evaluation of at least one of the following: a selected diagnosis, a troubleshooting pathway, and a time to determine a selected diagnosis.

16. The automotive diagnostic digital training method recited in claim 1, further comprising the step of monitoring a diagnostic process adopted by the student.

17. The automotive diagnostic digital training method recited in claim 16, wherein the step of monitoring a diagnostic process includes reviewing signals sent between the student workstation and the selected virtual vehicle.

18. The automotive diagnostic digital training method recited in claim 16, further comprising the step of identifying portions of the diagnostic process that deviate from a preferred diagnostic process.

19. The automotive diagnostic digital training method recited in claim 18, wherein the portions of the diagnostic process that deviate from the preferred diagnostic process include a request for sensor data functionally unrelated to the specified diagnostic condition.

20. The automotive diagnostic digital training method recited in claim 1, further comprising the step of displaying a configuration of the diagnostic systems of the virtual vehicle.

21. The automotive diagnostic digital training method recited in claim 1, further comprising the step of enabling display of data from multiple data sources on the student workstation, the multiple data sources includes the selected virtual vehicle and a data source separate from the selected virtual vehicle.

22. The automotive diagnostic digital training method recited in claim 21, wherein at least one of the multiple data sources includes an automotive reference manual.

23. The automotive diagnostic digital training method recited in claim 1, wherein the step of configuring the virtual vehicle includes connecting a physical vehicle input component to a physical vehicle electronic control unit (ECU).

24. The automotive diagnostic digital training method recited in claim 23, further comprising the step of connecting a main controller operatively between the physical vehicle input component and the physical vehicle ECU, the main controller being configured to facilitate communication between the physical vehicle input component and the physical vehicle ECU.

25. The automotive diagnostic digital training method recited in claim 24, wherein the step of configuring the virtual vehicle to simulate the specified vehicle condition includes receiving a desired condition signal at the main controller from an instructor device.

26. The automotive diagnostic digital training method 23, wherein the step of enabling a student workstation includes facilitating connection between a student device and the physical vehicle ECU.

27. The automotive diagnostic digital training method recited in claim 1, wherein the step of configuring the virtual vehicle includes connecting a physical vehicle electronic control unit (ECU) to a plurality of light emitting devices, each light emitting device being associated with a respective one of a vehicle input component and a vehicle output component.

28. The automotive diagnostic digital training system recited in claim 1, wherein the step of configuring the selected virtual vehicle to simulate one or more specified diagnostic system of the actual vehicle includes configuring the selected virtual vehicle to simulate the functionality of the diagnostic systems of the selected virtual vehicle.

29. The automotive diagnostic digital training system recited in claim 1, wherein the step of enabling a student workstation to access the selected virtual vehicle in a manner to simulate accessing the diagnostic systems of the actual vehicle includes enabling the student workstation to access the selected virtual vehicle through a simulated on board diagnostics (OBD) vehicle diagnostic port.

30. The automotive diagnostic digital training system recited in claim 1, wherein the student's interface in the evaluating step includes accessing, retrieving, and evaluating data from the selected virtual vehicle in an ordered and efficient manner according to one or more prescribed evaluation factors

31. An automotive diagnostic digital training system for teaching a student how to diagnose an actual vehicle through the use of a learning system configured to present selectable virtual vehicles having diagnostic systems corresponding to the actual vehicle and gauging the student's ability to diagnose a specified diagnostic condition on the virtual vehicle, the system comprising:
a virtual vehicle configured to generate a signal including a desired set of simulated vehicle-specific vehicle data;
a student workstation disposable in communication with the virtual vehicle, the student workstation including a handheld diagnostic device configured to communicate with the virtual vehicle to receive the simulated, vehicle-specific vehicle data therefrom and generate a student input signal representative of a student diagnostic decision; and
an instructor controller disposable in communication with the virtual vehicle and the student workstation, the instructor controller being configured to provide instructor input regarding the desired set of simulated, vehicle-specific vehicle data and review the student input.

32. The system recited in claim 31, wherein the virtual vehicle includes a physical vehicle input component and a physical vehicle electronic control unit (ECU) in communication with the physical vehicle input component.

33. The automotive diagnostic digital training method recited in claim 32, wherein the physical vehicle input is a physical vehicle sensor.

34. The automotive diagnostic digital training method recited in claim 31, wherein the virtual vehicle includes a data simulating processor and a database in communication with the data simulating processor and having simulated, vehicle-specific vehicle data stored thereon, the data simulating processor being configured to access simulated vehicle data stored on the database and generate the signal including a desired set of simulated vehicle data.

35. The system recited in claim 31, wherein the desired set of simulated vehicle data is selected from the list comprising: vehicle identification information, diagnostic trouble codes, live data, technical service bulletins, and service manual information.

36. The system recited in claim 31, wherein the instructor controller includes an algorithm having preprogrammed instructions for providing instructor related input.

37. The system recited in claim 31, wherein the instructor controller includes a processor having machine-learning capabilities adapted to provide instructor related input based on the student diagnostic decision.
